(19) United States
(12) Patent Application Publication
(10) Pub. No.: US 2024/0211721 A1
(43) Pub. Date: Jun. 27, 2024

(54) ADAPTIVE DEEP LEARNING INFERENCE METHOD AND APPARATUS, AND STORAGE MEDIUM STORING INSTRUCTIONS TO PERFORM ADAPTIVE DEEP LEARNING INFERENCE METHOD

(71) Applicant: Korea Advanced Institute of Science and Technology, Daejeon (KR)

(72) Inventors: Sung-Ju LEE, Daejeon (KR); Dong Hwi KIM, Daejeon (KR); HyungJun YOON, Daejeon (KR); Yewon KIM, Daejeon (KR); Sujin HAN, Daejeon (KR)

(21) Appl. No.: 18/389,848

(22) Filed: Dec. 20, 2023

(30) Foreign Application Priority Data
Dec. 21, 2022 (KR) 10-2022-0180842
May 10, 2023 (KR) 10-2023-0060780

(51) Int. Cl. G06N 3/04; G06N 3/082

(52) U.S. Cl. CPC G06N 3/04; G06N 3/082

(57) ABSTRACT

There is provided a method for inferring a result data corresponding to an input data using an adaptive deep learning model in a mobile terminal including a memory and a processor. The method comprises determining computing resource information of the mobile terminal; determining a basic deep learning model stored in the memory of the mobile terminal; generating the adaptive deep learning model by transforming the basic deep learning model based on allocable resources determined with reference to the computing resource information of the the mobile terminal, wherein the adaptive deep learning model has a number of layers less than the basic deep learning model; and inputting the input data into the adaptive deep learning model in the mobile terminal to determine the inferred result data to be outputted from the adaptive deep learning model.

### TECHNICAL FIELD

The present disclosure relates to an adaptive deep learning inference method and apparatus using a dynamic resource adaptive deep learning model.

This work was supported by Institute of Information & communications Technology Planning & Evaluation (IITP) grant funded by Korea government (MSIT) (Project No .: 2022-0-00495, and Research Project Title: Development of voice phishing detection and prevention technology on mobile phone devices).

### BACKGROUND

With the recent advent of 5G mobile communication technology, mobile services utilizing deep learning model inference technology are receiving great attention in the industry. The performance of these mobile services may vary depending on dynamically changing service requests, computing resources and network environments of inference terminals, and a deep learning model which is used. For example, if inference is performed in a cloud server with many computing resources and a well-trained model, a high inference speed and accuracy performance are achieved, but if inference is performed on a mobile device with few computing resources and a small learning model, results may be obtained in real time but inference speed and accuracy performance may decrease.

Such deep learning model inference technology necessarily involves input of user data. If deep learning model inference is performed on a cloud server and user data includes sensitive personal information, personal information leakage may occur in the process of transmitting a data to the server. Accordingly, the need for deep learning model inference technology that allows all data to be stored and computed within a terminal carried by the individual is increasing.

Meanwhile, according to the prior art regarding deep learning model inference within a terminal, the amount of computation used in inference and the size of a model itself are reduced by pruning nodes or layers within a network structure of a deep learning model designed for deep learning model inference in a mobile terminal (for example, a smartphone or IoT device) with limited computing resources or resources or designing a smaller model and then using knowledge distillation to perform transfer learning on an existing model. However, although these methods are suitable to design a deep learning model that can be executed in a limited computing environment, the amount of computation used for inference decreases as the size of the model decreases, thereby reducing the accuracy of inference.

Accordingly, there is a need to design a deep learning model that responds to computing resources or resources that dynamically change within a mobile terminal to ensure an appropriate balance between model lightweighting and model performance degradation.

### SUMMARY

An object of the present disclosure is to provide a dynamic resource adaptive deep learning model inference method of acquiring resource information regarding a mobile terminal, lightweighting a basic deep learning model into a adaptive deep learning model on the basis of allocable resources determined by referring to the resource information regarding the mobile terminal, and performing inference using the adaptive deep learning model in the mobile terminal.

The aspects of the present disclosure are not limited to the foregoing, and other aspects not mentioned herein will be clearly understood by those skilled in the art from the following description.

In accordance with an aspect of the present disclosure, there is provided a method for inferring a result data corresponding to an input data using an adaptive deep learning model in a mobile terminal including a memory and a processor, the method comprises: determining computing resource information of the mobile terminal; determining a basic deep learning model stored in the memory of the mobile terminal; generating the adaptive deep learning model by transforming the basic deep learning model based on allocable resources determined with reference to the computing resource information of the the mobile terminal, wherein the adaptive deep learning model has a number of layers less than the basic deep learning model; and inputting the input data into the adaptive deep learning model in the mobile terminal to determine the inferred result data to be outputted from the adaptive deep learning model.

The computing resource information of the mobile terminal may include at least one of storage capacity information, memory usage information, and processor usage information of the mobile terminal.

The mobile terminal may include a graphic processing unit (GPU) or a neural network processing unit (NPU), and the computing resource information may include GPU usage information or NPU usage information.

The computing resource information may change over time.

The generating the adaptive deep learning model may include: estimating resource information required to process the basic deep learning model; determining the allocable resources based on the computing resource information and the computing resource information required to process the basic deep learning model; and generating the adaptive deep learning model by transforming the basic deep learning model with reference to the allocable resources.

The allocable resources may be determined with reference to the computing resource information at the time of starting inference of the adaptive deep learning model.

The determining of the allocable resources may include determining a target downsize ratio associated with a minimum ratio of ratios of predetermined first values included in the resource information required to process the basic deep learning model and predetermined second values included in the computing resource information, and the generating the adaptive deep learning model may include adjusting the number of layers included in the basic deep learning model based on the target downsize ratio.

In accordance with another aspect of the present disclosure, there is provided an apparatus for inferring a result data corresponding to an input data using an adaptive deep learning model in a mobile terminal, the apparatus comprises: a memory configured to store one or more instructions and a basic deep learning model; and a processor configured to execute the one or more instructions stored in the memory, wherein the instructions, when executed by the processor, cause the processor to: determine computing resource information of a mobile terminal; determine the basic deep learning model stored in the memory; generate the adaptive deep learning model by transforming the basic deep learning model based on allocable resources determined with reference to the computing resource information of the the mobile terminal, wherein the adaptive deep learning model has a number of layers less than the basic deep learning model; and input the input data into the adaptive deep learning model in the mobile terminal to determine the inferred result data to be outputted from the adaptive deep learning model.

The computing resource information of the mobile terminal may include at least one of storage capacity information, memory usage information, and processor usage information.

The mobile terminal may include a graphic processing unit (GPU) or a neural network processing unit (NPU), and the computing resource information may include GPU usage information or NPU usage information.

The computing resource information may change over time.

The processor may be configured to: estimate resource information required to process the basic deep learning model; determine the allocable resources based on the computing resource information and the computing resource information required to process the basic deep learning model; and generate the adaptive deep learning model by transforming with reference to the allocable resources.

The allocable resources may be determined with reference to the computing resource information at the time of starting inference of the adaptive deep learning model.

The processor may be configured to determine a target downsize ratio associated with a minimum ratio of ratios of predetermined first values included in the resource information required to process the basic deep learning model and predetermined second values included in the computing resource information and to adjust the number of layers included in the basic deep learning model based on the target downsize ratio.

In accordance with another aspect of the present disclosure, there is provided a non-transitory computer-readable recording medium storing a computer program, which comprises instructions for a processor to perform a method for inferring a result data corresponding to an input data using an adaptive deep learning model in a mobile terminal, the method comprise: determining computing resource information of the mobile terminal; determining a basic deep learning model stored in the memory of the mobile terminal; generating the adaptive deep learning model by transforming the basic deep learning model based on allocable resources determined with reference to the computing resource information of the the mobile terminal, wherein the adaptive deep learning model has a number of layers less than the basic deep learning model; and inputting the input data into the adaptive deep learning model in the mobile terminal to determine the inferred result data to be outputted from the adaptive deep learning model.

According to an embodiment of the present disclosure, it is possible to achieve the effect of performing inference using a deep learning model lightweighted to have optimal performance in a limited resource environment by tracking resources of a mobile terminal in real time and adjusting a lightweighting level for performing the function of the deep learning model in the mobile terminal.

In addition, according to an embodiment of the present disclosure, a target lightweighting ratio is determined with reference to allocable resources to achieve the effect of preventing situations in which inference of a deep model is limited even if some of available resources are exhausted due to the use of other applications or the operation of an operating system in a mobile terminal.

Furthermore, according to an embodiment of the present disclosure, the effect of significantly reducing the possibility of personal information leakage can be achieved as inference of a deep learning model is performed in a mobile terminal rather than a cloud server.

### BRIEF DESCRIPTION OF THE DRAWINGS

FIG. 1 is a block diagram showing a deep learning model inference apparatus according to an embodiment of the present disclosure.

FIG. 2 is a block diagram conceptually showing the function of a deep learning model inference program according to an embodiment of the present disclosure.

FIG. 3 is a flowchart showing a deep learning model inference method according to an embodiment of the present disclosure.

FIG. 4 is a flowchart showing a deep learning model lightweighting method according to an embodiment of the present disclosure.

FIG. 5 is a diagram illustrating a lightweight adaptive deep learning model obtained with reference to resource information regarding a basic deep learning model and resource information regarding a mobile terminal according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

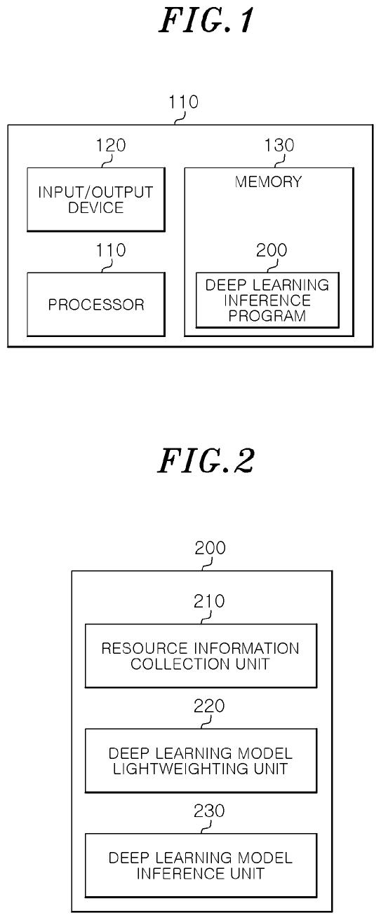

FIG. 1 is a block diagram showing a deep learning model inference apparatus according to an embodiment of the present disclosure.

Referring to FIG. 1, the deep learning model inference apparatus 100 may include a processor 110, an input/output device 120, and a memory 130.

The processor 110 may generally control the operation of the deep learning model inference apparatus 100.

The processor 110 can receive resource information regarding a mobile terminal using the input/output device 120. Additionally, the processor 110 may receive resource information regarding a basic deep learning model using the input/output device 120.

In the present disclosure, a mobile terminal may be a smartphone, a device with a limited resource state similar to that of the smartphone, or an IoT device.

In addition, in the present disclosure, the basic deep learning model may be an artificial intelligence model that receives predetermined data (e.g., voice data and image data) and performs predetermined inference (e.g., classification of voice data, classification of image data, object detection, and the like).

Resource information according to an embodiment of the present disclosure may refer to information on computable resources obtained from computing resources (or environment) in association with the mobile terminal or the basic deep learning model. For example, resource information may include hardware information, software information, storage capacity information, memory usage information, CPU usage information, heat generation information, or GPU/NPU usage information, which will be described later.

Although the resource information regarding the mobile terminal and the resource information regarding the basic deep learning model are input through the input/output device 120 in the present disclosure, the present disclosure is not limited thereto. That is, according to an embodiment, the deep learning model inference apparatus 100 may include a transceiver (not shown) and obtain at least one of the resource information regarding the mobile terminal or the resource information regarding the basic deep learning model using the transceiver (not shown), and at least one of the resource information regarding the mobile terminal or the resource information regarding the basic deep learning model may be generated in the deep learning model inference apparatus 100.

The processor 110 may obtain the resource information regarding the mobile terminal, lightweight the basic deep learning model into a adaptive deep learning model on the basis of allocable resources determined with reference to the resource information regarding the mobile terminal, and perform inference using the adaptive deep learning model in the mobile terminal.

The input/output device 120 may include one or more input devices and/or one or more output devices. For example, input devices may include a microphone, a keyboard, a mouse, a touch screen, and the like, and output devices may include a display, a speaker, and the like.

The memory 130 may store a deep learning model inference program 200 and information necessary for execution of the deep learning model inference program 200.

In the present disclosure, the deep learning model inference program 200 may refer to software including instructions for receiving the resource information regarding the mobile terminal and performing inference using the adaptive deep learning model in the mobile terminal.

The processor 110 may load the deep learning model inference program 200 and the information necessary for execution of the deep learning model inference program 200 from the memory 130 in order to execute the deep learning model inference program 200.

The processor 110 may lightweight the basic deep learning model into the adaptive deep learning model and perform inference using the adaptive deep learning model in the mobile terminal by executing the deep learning model inference program 200. The process of lightweighting the basic deep learning model into the adaptive deep learning model according to an embodiment of the present disclosure will be described later.

The function and/or operation of the deep learning model inference program 200 will be described in detail with reference to FIG. 2.

FIG. 2 is a block diagram conceptually showing the function of the deep learning model inference program according to an embodiment of the present disclosure.

Referring to FIG. 2, the deep learning model inference program 200 may include a resource information collection unit 210, a deep learning model lightweighting unit 220, and a deep learning model inference unit 230.

The resource information collection unit 210, the deep learning model lightweighting unit 220, and the deep learning model inference unit 230 shown in FIG. 2 are conceptually divided blocks of the deep learning model inference program 200 in order to easily describe the function of the deep learning model inference program 200, and the present disclosure is not limited thereto. According to embodiments, the functions of the resource information collection unit 210, the deep learning model lightweighting unit 220, and the deep learning model inference unit 230 may be combined/separated, and may be implemented by a series of instructions included in one program.

First, the resource information collection unit 210 can obtain resource information regarding a mobile terminal.

Here, resource information regarding a mobile terminal according to an embodiment of the present disclosure may include at least one of hardware information, software information, storage capacity information, memory usage information, CPU usage information, or GPU/NPU usage information of the mobile terminal.

Specifically, the hardware information of the mobile terminal may refer to information on hardware resources in a static state of the mobile terminal and may include information on the CPU specifications, memory specifications, presence or absence of a GPU, and presence or absence of NPU in the device.

In addition, the software information of the mobile terminal may refer to information on software resources according to the operating system (OS) environment of the mobile terminal and may include information on the amount of CPU computations that can be executed depending on the constraints of the operating system environment or the number of processes that can be simultaneously executed.

Additionally, the storage capacity information of the mobile terminal may refer to information on the storage capacity resources required for inference of a deep learning model in the mobile terminal.

Additionally, the memory usage information of the mobile terminal may refer to information on available memory computation resources required for inference of a deep learning model in the mobile terminal.

In addition, the CPU usage information of the mobile terminal according to an embodiment of the present disclosure may refer to information on resources required for CPU computations required for inference of a deep learning model even when other applications are being used in the mobile terminal. Here, the CPU usage information of the mobile terminal may vary depending on the degree of heat generation of the mobile terminal.

In addition, the GPU/NPU usage information of the mobile terminal according to an embodiment of the present disclosure may refer to information on resources required for computations of a graphic work necessary for inference of a deep learning model even when other graphic works are simultaneously performed when the mobile terminal is a device with a GPU/NPU.

The resource information collection unit 210 may obtain resource information regarding the basic deep learning model. Here, the basic deep learning model according to an embodiment of the present disclosure may mean the original deep learning model.

Specifically, the resource information regarding the basic deep learning model according to an embodiment of the present disclosure may refer to information on computational resources required for the original deep learning model to perform inference (e.g., storage capacity information, memory usage information, CPU usage information, and GPU/NPU usage information of the basic deep learning model).

Here, the resource information regarding the basic deep learning model according to an embodiment of the present disclosure may be estimated on the basis of the numbers of nodes and parameters constituting the basic deep learning model, and thus the resource information collection unit 210 need not necessarily obtain the resource information.

The resource information collection unit 210 can track resource information regarding the mobile terminal in real time.

Specifically, the resource information regarding the mobile terminal according to an embodiment of the present disclosure may change over time, and the resource information collection unit 210 may track and obtain the resource information regarding the mobile terminal that changes in real time over time.

Accordingly, the effect of performing inference using a lightweight deep learning model in a limited resource situation can be achieved by lightweighting the original deep learning model to correspond to the resource information regarding the mobile terminal that changes in real time over time.

Next, the deep learning model lightweighting unit 220 can lightweight the basic deep learning model into a adaptive deep learning model on the basis of allocable resources determined with reference to the resource information regarding the mobile terminal.

Specifically, the deep learning model lightweighting unit 220 according to an embodiment of the present disclosure can estimate the resource information regarding the basic deep learning model.

More specifically, the deep learning model lightweighting unit 220 may estimate storage capacity information, memory usage information, CPU usage information or GPU/NPU usage information used to perform inference using the basic deep learning model on the basis of the numbers of nodes and parameters constituting the basic deep learning model.

For example, if it is assumed that the basic deep learning model is composed of 10 integer nodes and 5 synapses and computation occurs at once, the deep learning model lightweighting unit 220 can estimate memory capacity used by the basic deep learning model as a value obtained by adding the size of parameters necessary for operation of the 5 integers to the capacity of the input and output of the basic deep learning model.

As another example, the deep learning model lightweighting unit 220 may estimate the storage space occupied by the basic deep learning model as the sum of bytes of 10 integer nodes and 5 synapse parameters.

Meanwhile, the deep learning model lightweighting unit 220 according to an embodiment of the present disclosure may determine allocable resources with reference to the resource information regarding the mobile terminal and the resource information regarding the basic deep learning model.

Here, the allocable resources according to an embodiment of the present disclosure may mean a maximum value of resources necessary to execute the inference function of the basic deep learning model in the mobile terminal in an environment in which the resource information regarding the mobile terminal and the resource information regarding the basic deep learning model are simultaneously considered.

Specifically, the deep learning model lightweighting unit 220 according to an embodiment of the present disclosure may determine a target lightweighting ratio associated with a minimum ratio of ratios of predetermined first values included in the resource information regarding the basic deep learning model and predetermined second values included in the resource information regarding the mobile terminal. Here, the target lightweighting ratio may mean a ratio equal to or less than ratios of the allocable resources and the resources of the basic deep learning model.

More specifically, the deep learning model lightweighting unit 220 according to an embodiment of the present disclosure may determine the target lightweighting ratio associated with a minimum ratio of the ratios of the predetermined first values in the resource information regarding the basic deep learning model and the second values corresponding to the predetermined first values in the resource information regarding the mobile terminal.

For example, on the assumption that the storage capacity is 2 GB, memory usage is 20 MB, and CPU usage is 30 FLOP in the basic deep learning model, and available storage capacity is 1 GB, available memory is 6 MB, and CPU resource is 40 FLOP in the mobile terminal, the storage capacity storage capacity is 1/2, the memory ratio is 3/10, and the CPU ratio is 4/3. Here, since the memory ratio 3/10 is the minimum ratio, the deep learning model lightweighting unit 220 can determine the memory ratio as a target lightweighting ratio.

As another example, the deep learning model lightweighting unit 220 may determines a ratio equal to or less than the memory ratio as a target lightweighting ratio with reference to a hyperparameter preset as a padding value in order to provide a free space in allocable resources.

Accordingly, even if a part of an available memory is exhausted due to the use of other applications or the operation of the operating system in the mobile terminal, it is possible to prevent a situation in which inference of a deep learning model is limited.

Further, the deep learning model lightweighting unit 220 may lightweight the basic deep learning model with reference to allocable resources.

Specifically, the deep learning model lightweighting unit 220 can lightweight the basic deep learning model using a structured dropout method for lightweighting an artificial neural network by pruning an N-th artificial neural network layer with a probability of P.

Here, the deep learning model lightweighting unit 220 may adjust the number of layers included in the basic deep learning model on the basis of the target lightweighting ratio. For example, on the assumption that the target lightweighting ratio is set as L, the deep learning model lightweighting unit 220 can lightweight the basic deep learning model by pruning every

$$\frac{1}{( 1 - L )} - th$$

artificial neural network layer among the layers included in the basic deep learning model with a probability of 100%.

Next, the deep learning model inference unit 230 may perform inference using the adaptive deep learning model obtained by lightweighting the basic deep learning model in the mobile terminal.

Meanwhile, allocable resources according to an embodiment of the present disclosure may be determined by referring to the resource information regarding the mobile terminal at the time of performing inference using the adaptive deep learning model.

Accordingly, allocable resources can be determined depending on a dynamically changing resource environment in the mobile terminal, and the effect of performing optimized inference using the lightweight adaptive deep learning model with reference to the allocable resources can be achieved.

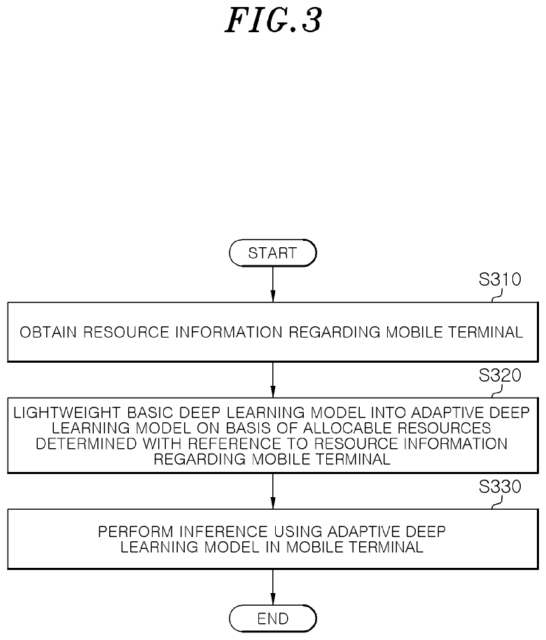

FIG. 3 is a flowchart showing a deep learning model inference method according to an embodiment of the present disclosure.

Referring to FIGS. 2 and 3, the resource information collection unit 210 may obtain resource information regarding a mobile terminal (S310).

Next, the deep learning model lightweighting unit 220 may lightweight the basic deep learning model into the adaptive deep learning model on the basis of allocable resources determined with reference to the resource information regarding the mobile terminal (S320).

Here, allocable resources according to an embodiment of the present disclosure mean a maximum value of resources necessary to execute the inference function of the basic deep learning model in the mobile terminal in an environment in which the resource information regarding the mobile terminal and the resource information regarding the basic deep learning model are simultaneously considered and may be determined with reference to the resource information regarding the mobile terminal at the time of starting interference using the adaptive deep learning model.

Next, the deep learning model inference unit 230 may perform inference using the adaptive deep learning model in the mobile terminal (S330).

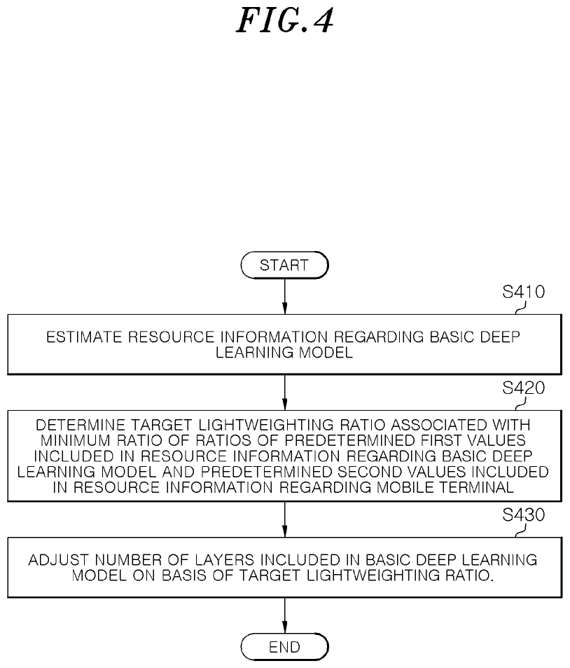

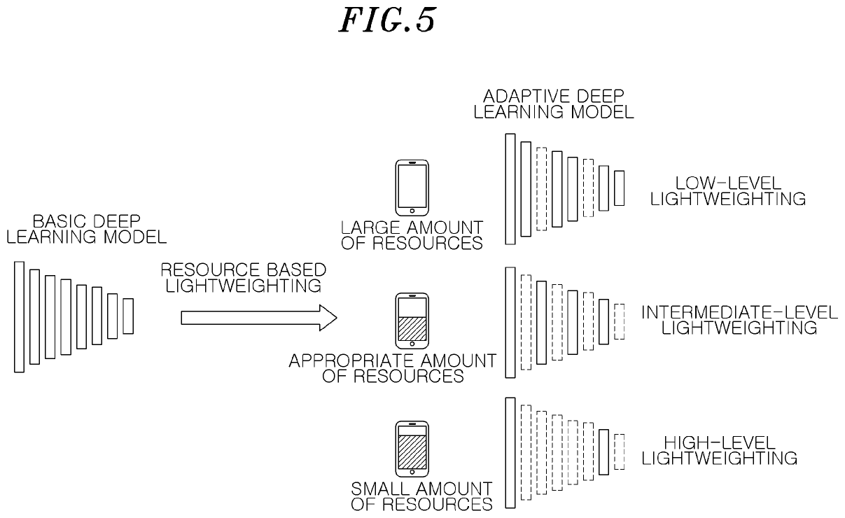

FIG. 4 is a flowchart showing a deep learning model lightweighting method according to an embodiment of the present disclosure.

Referring to FIGS. 2 and 4, the deep learning model lightweighting unit 220 may estimate resource information regarding the basic deep learning model (S410).

Next, the deep learning model lightweighting unit 220 may determine a target lightweighting ratio associated with a minimum ratio of ratios of predetermined first values included in the resource information regarding the basic deep learning model and predetermined second values included in the resource information regarding the mobile terminal (S420).

Here, the deep learning model lightweight unit 220 may determine a target lightweighting ratio associated with the minimum ratio of the ratios of the predetermined first values in the resource information regarding the basic deep learning model and the second values corresponding to the predetermined first values in the resource information regarding the mobile terminal.

Next, the deep learning model lightweighting unit 220 may adjust the number of layers included in the basic deep learning model on the basis of the target lightweighting ratio (S430).

FIG. 5 is a diagram illustrating a lightweight adaptive deep learning model obtained with reference to the resource information regarding the basic deep learning model and the resource information regarding the mobile terminal according to an embodiment of the present disclosure.

Referring to FIGS. 2 and 5, the resource information regarding the mobile terminal may change over time.

When there are many allocable resources, the target lightweighting ratio can be determined to be high, and the deep learning model lightweighting unit 220 can lightweight the basic deep learning model to a low level.

When the amount of allocable resources is appropriate, the target lightweighting ratio can be appropriately determined, and the deep learning model lightweighting unit 220 can lightweight the basic deep learning model to an intermediate level.

When the amount of allocable resources is insufficient, the target lightweighting ratio can be determined to be low, and the deep learning model lightweighting unit 220 can lightweight the basic deep learning model to a high level.

Here, since the basic deep learning model is lightweighted by referring to the allocable resources, the adaptive deep learning model corresponding to the low-level lightweighting, the adaptive deep learning model corresponding to the intermediate-level lightweighting, and the adaptive deep learning model corresponding to the high-level lightweighting may have differences in performance, but they can execute the inference function of the basic deep learning model which is the original deep learning model in the mobile terminal.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for inferring a result data corresponding to an input data using an adaptive deep learning model in a mobile terminal including a memory and a processor, the method comprising:
determining computing resource information of the mobile terminal;
determining a basic deep learning model stored in the memory of the mobile terminal;
generating the adaptive deep learning model by transforming the basic deep learning model based on allocable resources determined with reference to the computing resource information of the the mobile terminal, wherein the adaptive deep learning model has a number of layers less than the basic deep learning model; and
inputting the input data into the adaptive deep learning model in the mobile terminal to determine the inferred result data to be outputted from the adaptive deep learning model.

2. The method of claim 1, wherein the computing resource information of the mobile terminal includes at least one of storage capacity information, memory usage information, and processor usage information of the mobile terminal.

3. The method of claim 2, wherein the mobile terminal further comprises a graphic processing unit (GPU) or a neural network processing unit (NPU), and
wherein the computing resource information includes GPU usage information or NPU usage information.

4. The method of claim 1, wherein the computing resource information changes over time.

5. The method of claim 1, wherein the generating the adaptive deep learning model includes:
estimating resource information required to process the basic deep learning model;
determining the allocable resources based on the computing resource information and the computing resource information required to process the basic deep learning model; and
generating the adaptive deep learning model by transforming the basic deep learning model with reference to the allocable resources.

6. The method of claim 1, wherein the allocable resources are determined with reference to the computing resource information at the time of starting inference of the adaptive deep learning model.

7. The method of claim 5, wherein the determining of the allocable resources includes determining a target downsize ratio associated with a minimum ratio of ratios of predetermined first values included in the resource information required to process the basic deep learning model and predetermined second values included in the computing resource information, and
wherein the generating the adaptive deep learning model includes adjusting the number of layers included in the basic deep learning model based on the target downsize ratio.

8. An apparatus for inferring a result data corresponding to an input data using an adaptive deep learning model in a mobile terminal, the apparatus comprising:
a memory configured to store one or more instructions and a basic deep learning model; and
a processor configured to execute the one or more instructions stored in the memory, wherein the instructions, when executed by the processor, cause the processor to:
determine computing resource information of a mobile terminal;
determine the basic deep learning model stored in the memory;
generate the adaptive deep learning model by transforming the basic deep learning model based on allocable resources determined with reference to the computing resource information of the the mobile terminal, wherein the adaptive deep learning model has a number of layers less than the basic deep learning model; and
input the input data into the adaptive deep learning model in the mobile terminal to determine the inferred result data to be outputted from the adaptive deep learning model.

9. The apparatus of claim 8, wherein the computing resource information of the mobile terminal includes at least one of storage capacity information, memory usage information, and processor usage information.

10. The apparatus of claim 9, wherein the mobile terminal further comprises a graphic processing unit (GPU) or a neural network processing unit (NPU), and
wherein the computing resource information includes GPU usage information or NPU usage information.

11. The apparatus of claim 8, wherein the computing resource information changes over time.

12. The apparatus of claim 8, wherein the processor is configured to:
estimate resource information required to process the basic deep learning model;
determine the allocable resources based on the computing resource information and the computing resource information required to process the basic deep learning model; and
generate the adaptive deep learning model by transforming with reference to the allocable resources.

13. The apparatus of claim 8, wherein the allocable resources are determined with reference to the computing resource information at the time of starting inference of the adaptive deep learning model.

14. The apparatus of claim 12, wherein the processor is configured to determine a target downsize ratio associated with a minimum ratio of ratios of predetermined first values included in the resource information required to process the basic deep learning model and predetermined second values included in the computing resource information and to adjust the number of layers included in the basic deep learning model based on the target downsize ratio.

15. A non-transitory computer readable storage medium storing computer executable instructions, wherein the instructions, when executed by a processor, cause the processor to perform a method for inferring a result data corresponding to an input data using an adaptive deep learning model in a mobile terminal, the method comprising:
determining computing resource information of the mobile terminal;
determining a basic deep learning model stored in a memory of the mobile terminal;
generating the adaptive deep learning model by transforming the basic deep learning model based on allocable resources determined with reference to the computing resource information of the the mobile terminal, wherein the adaptive deep learning model has a number of layers less than the basic deep learning model; and
inputting the input data into the adaptive deep learning model in the mobile terminal to determine the inferred result data to be outputted from the adaptive deep learning model.
